(19) United States
(12) Patent Application Publication
(10) Pub. No.: US 2026/0326508 A1
(43) Pub. Date: Oct. 22, 2026

(54) HEAT TRANSPORT SYSTEM FOR A VEHICLE

(71) Applicant: Ford Global Technologies, LLC, Dearborn, MI (US)

(72) Inventors: David Lostrek, Cologne (DE); Maximilian Klein, Korschenbroich (DE); Klaus Schuermanns, Cologne (DE); Funda Kahraman, Cologne (DE); Alice Maria Kheir Bek, Cologne (DE)

(73) Assignee: Ford Global Technologies, LLC, Dearborn, MI (US)

(21) Appl. No.: 19/558,767

(22) Filed: Mar. 6, 2026

(30) Foreign Application Priority Data
Apr. 18, 2025 (DE) 102025115357.4

(51) Int. Cl. B60H 1/32

(52) U.S. Cl. CPC B60H 1/321; B60H 1/32284; B60H 1/323; B60H 2001/3261; B60H 2001/3263

(57) ABSTRACT

A heat transport system for a vehicle having a plurality of ambient heat exchangers, each of which is designed for heat exchange with an air flow and, in a heating mode of the heat transport system, is fluidically connected via an ambient circuit to a primary heat exchanger by which heat is able to be supplied at least indirectly to a vehicle zone. The heat transport system has a system control unit designed to apply a defined de-icing criterion in order to establish a need for de-icing in at least one of the ambient heat exchangers to select as a passive ambient heat exchanger and to transfer the heat transport system into a de-icing mode, while fluid exchange between the at least one passive ambient heat exchanger and the primary heat exchanger is at least restricted compared with the heating mode.

### CROSS-REFERENCE TO RELATED APPLICATION

This application claims foreign priority benefits under 35 U.S.C. § 119(a)-(d) to German Application No. DE102025115357.4 filed Apr. 18, 2025, which is hereby incorporated by reference in its entirety.

### FIELD OF THE DISCLOSURE

The present disclosure generally relates to a heat transport system for a vehicle.

### BACKGROUND OF THE DISCLOSURE

Motor vehicles with an internal combustion engine may use the waste heat of the engine to heat the vehicle interior, which is not possible in electric vehicles in the same way. This may apply to battery-powered electric vehicles, to hybrid vehicles and to fuel cell vehicles. It may be possible to heat the interior using an electric PTC heater, but this may be inefficient in terms of energy. Therefore, in such electric vehicles, a refrigerant-based heat pump system may be made to generate heat more efficiently. A significant proportion of the heat required for heating is generally taken from the ambient air surrounding the vehicle. This generally increases the efficiency compared with a PTC heater. However, the efficiency typically decreases in cold ambient conditions, for example below −10 °C. Also, below an ambient temperature of about 5 °C, the possibility increases, in heat pump operation, of the heat exchanger on the surroundings side icing up when air humidity or water droplets from the surroundings freeze on the cooler heat exchanger which may result in the air channels thereof becoming closed up. To prevent or eliminate such icing up, it is possible to periodically heat up the heat exchanger on the surroundings side by use of the heat pump fluid flowing through it, wherein the heat can be taken from heat sources within the vehicle. During such de-icing, however, the heat exchanger may not available for extracting heat from the ambient air. The heating of the vehicle heating either may have to be periodically interrupted, or heat may have to be taken from other sources, for example, from a PTC heater, which may result in inefficient and less than reliable heating of the vehicle interior.

It would be desirable to provide for energy-efficient heatability, as free of interruptions as possible, of the interior of an electric vehicle.

### SUMMARY OF THE DISCLOSURE

According to a first aspect of the present disclosure, a heat transport system for a vehicle has a plurality of ambient heat exchangers, each designed for heat exchange with an air flow and, in a heating mode of the heat transport system, fluidically connected via an ambient circuit to a primary heat exchanger such that heat is supplied at least indirectly to a vehicle zone. A control unit is designed to apply a defined de-icing criterion in order to establish a need for de-icing in at least one of the plurality of ambient heat exchangers, to select the at least one of the plurality of ambient heat exchangers as a passive ambient heat exchanger and to transfer the heat transport system into a de-icing mode in which at least one active ambient heat exchanger is fluidically connected to the primary heat exchanger, while fluid exchange between the passive ambient heat exchanger and the primary heat exchanger is restricted compared with the heating mode.

Embodiments of the first aspect of the present disclosure can include any one or a combination of the following features:
the primary heat exchanger is fluidically connected to a secondary heat exchanger by a primary circuit, wherein the primary circuit is configured as a heat pump circuit and has a compressor and an expansion valve, and wherein, in the heating mode, heat is transferable from the primary heat exchanger to the vehicle zone via the secondary heat exchanger, and wherein the ambient circuit forms an ambient secondary circuit;
the secondary heat exchanger is fluidically connected via a vehicle secondary circuit to a heating heat exchanger which is assigned to the vehicle zone, wherein, in the de-icing mode, the at least one passive ambient heat exchanger is fluidically connected to the vehicle secondary circuit via a connecting arrangement in parallel with the heating heat exchanger;
the system may comprise a sensor, wherein the de-icing criterion is based at least partially on measurement data from the at least one sensor;
the system control unit is designed to determine, for at least one ambient heat exchanger, an icing index which corresponds to a difference between a fluid temperature associated with the at least one ambient heat exchanger and an ambient temperature, and to identify a need for de-icing at least partially based on the icing index;
the system control unit is designed to select the at least one passive ambient heat exchanger at least partially based on a comparison of icing indices of a plurality of ambient heat exchangers;
the system control unit is designed to select the at least one passive ambient heat exchanger at least partially based on a defined prioritization of the ambient heat exchangers;
the system control unit is designed to transfer the heat transport system into a de-icing mode depending on whether a need for de-icing is identified in a plurality of ambient heat exchangers that corresponds at least to a defined minimum number;
the system control unit is designed, in the de-icing mode, to check a need for de-icing of a passive ambient heat exchanger and to operate the latter as an active ambient heat exchanger if there is no longer a need for de-icing; and
the system may comprise an adjustable blocking unit, which is actuable by the system control unit such that, in the de-icing mode, compared with the heating mode, the adjustable blocking unit reduces a first partial air flow that flows into at least one passive ambient heat exchanger in relation to a second partial air flow that flows into at least one active ambient heat exchanger.

According to a second aspect of the present disclosure, a heat transport system for a vehicle has a plurality of ambient heat exchangers, which is designed for heat exchange with an air flow and, in a heating mode of the heat transport system, fluidically connected via an ambient circuit to a primary heat exchanger such that heat is supplied at least indirectly to a vehicle zone, wherein the primary heat exchanger is fluidically connected to a secondary heat exchanger by a primary circuit, wherein the primary circuit is configured as a heat pump circuit and has a compressor and an expansion valve, and wherein, in the heating mode, heat is transferable from the primary heat exchanger to the vehicle zone via the secondary heat exchanger, wherein the ambient circuit forms an ambient secondary circuit, and wherein the secondary heat exchanger is fluidically connected via a vehicle secondary circuit to a heating heat exchanger which is assigned to the vehicle zone, wherein, in a de-icing mode, the at least one passive ambient heat exchanger is fluidically connected to the vehicle secondary circuit via a connecting arrangement in parallel with the heating heat exchanger. A control unit is designed to apply a defined de-icing criterion in order to establish a need for de-icing in at least one of the plurality of ambient heat exchangers, to select the at least one of the plurality of ambient heat exchangers as a passive ambient heat exchanger and to transfer the heat transport system into the de-icing mode in which at least one active ambient heat exchanger is fluidically connected to the primary heat exchanger, while fluid exchange between the passive ambient heat exchanger and the primary heat exchanger is restricted compared with the heating mode. The system further has a sensor, wherein the de-icing criterion is based at least partially on measurement data from the at least one sensor.

Embodiments of the second aspect of the present disclosure can include any one or a combination of the following features:
the control unit is designed to determine, for at least one ambient heat exchanger, an icing index which corresponds to a difference between a fluid temperature associated with the at least one ambient heat exchanger and an ambient temperature, and to identify a need for de-icing at least partially based on the icing index;
the control unit is designed to select the at least one passive ambient heat exchanger at least partially based on a comparison of icing indices of a plurality of ambient heat exchangers;
the control unit is designed to select the at least one passive ambient heat exchanger at least partially based on a defined prioritization of the ambient heat exchangers;
the control unit is designed to transfer the heat transport system into a de-icing mode depending on whether a need for de-icing is identified in a plurality of ambient heat exchangers that corresponds at least to a defined minimum number;
the control unit is designed, in the de-icing mode, to check a need for de-icing of a passive ambient heat exchanger and to operate the latter as an active ambient heat exchanger if there is no longer a need for de-icing; and
the system may include an adjustable blocking unit, which is actuable by the control unit such that, in the de-icing mode, compared with the heating mode, the adjustable blocking unit reduces a first partial air flow that flows into at least one passive ambient heat exchanger in relation to a second partial air flow that flows into at least one active ambient heat exchanger.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a schematic side illustration of an electric vehicle having a heat transport system according to one example;

FIG. 2 is a perspective illustration of an ambient heat exchanger unit of the heat transport system in FIG. 1;

FIG. 3 is a partially exploded perspective illustration of the ambient heat exchanger unit in FIG. 2;

FIG. 4 is a diagrammatic illustration of the heat transport system in FIG. 1;

FIG. 5 is a block diagram with components of the electric vehicle in FIG. 1;

FIG. 6 is a diagrammatic illustration of a part of the heat transport system in FIG. 4 in a heating mode;

FIG. 7 is a diagrammatic illustration corresponding to FIG. 6 in a first de-icing mode;

FIG. 8 is a diagrammatic illustration corresponding to FIG. 6 in a second de-icing mode;

FIG. 9 is a flow chart of a method that is able to be carried out by the heat transport system in FIG. 1;

FIG. 10 is a flow chart of a method that is able to be carried out by a further heat transport system according to one example;

FIG. 10A is a flow chart illustrating sub-steps of the flow chart in FIG. 10;

FIG. 11 is a flow chart of a method that is able to be carried out by a further heat transport system according to the disclosure; and

FIG. 11A is a flow chart illustrating sub-steps of the flow chart in FIG. 11.

### DETAILED DESCRIPTION OF PREFERRED EMBODIMENTS

In the different figures, identical parts are always provided with the same reference signs, and so these parts are generally also described only once.

It should be noted that the features and measures specified individually in the following description can be combined with one another in any desired technically meaningful way and disclose further refinements of the disclosure. The description additionally characterizes and specifies the disclosure, in particular in conjunction with the figures. The terms “first”, “second” etc. which are used in this application serve only for the purpose of differentiation. In particular, their use is not intended to imply any sequence or priority of the objects specified in conjunction with these terms.

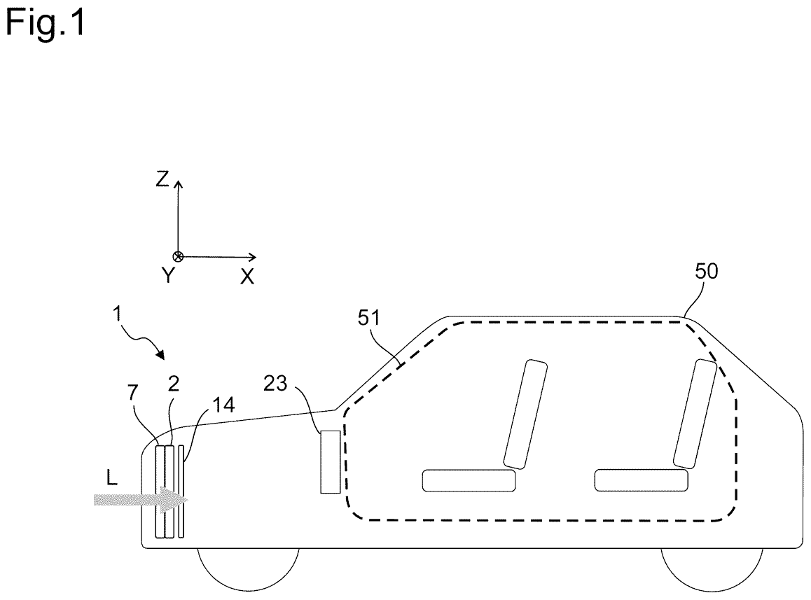

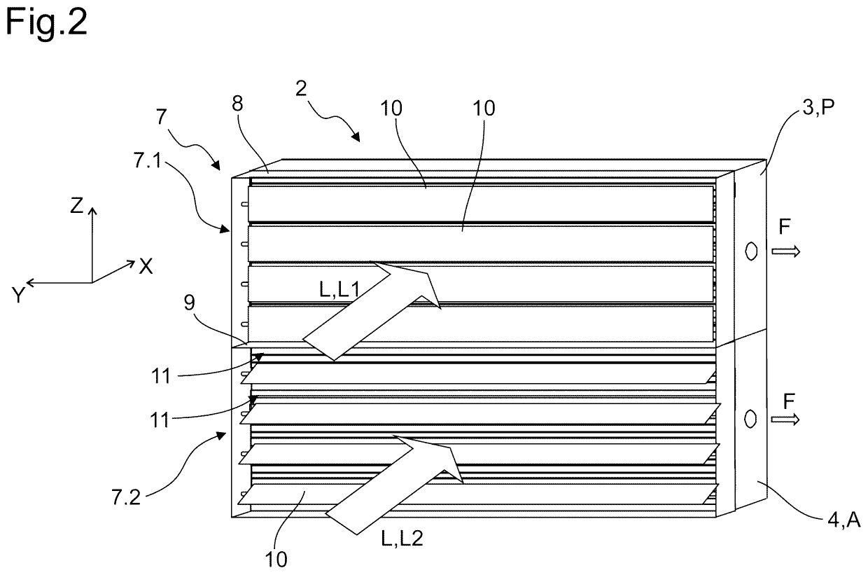

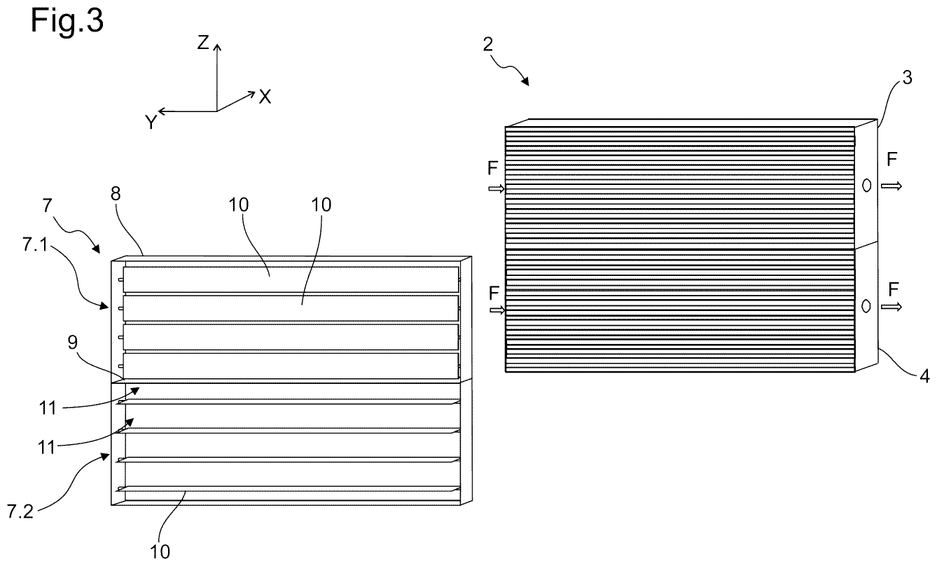

FIG. 1 shows a motor vehicle 50 configured as a battery-powered electric vehicle (BEV), having parts of a heat transport system 1 according to one embodiment. In the figures, a longitudinal axis X, a transverse axis Y and a vertical axis Z of the vehicle 50 are indicated. An interior 51, which can also be referred to as a passenger compartment, is schematically illustrated. Arranged in the front region of the vehicle 50 is an ambient heat exchanger unit 2, which is illustrated separately in FIGS. 2 and 3 and has two ambient heat exchangers 3, 4. These ambient heat exchangers 3, 4 are intended to extract heat from an air flow L in a heating mode of the heat transport system 1, the heat being intended to be supplied to a heating heat exchanger 23 via the heat transport system 1. The interior 51 can be heated by use of the heating heat exchanger 23. The interior 51 represents an example of a vehicle zone, wherein, alternatively, heating of other vehicle zones can also be provided, for example a vehicle battery (not illustrated here) or power electronics. Arranged behind the ambient heat exchanger unit 2 with regard to the longitudinal axis X is a fan unit 14, which is able to be operated electrically and which can at least partially generate the air flow L if a driving movement of the vehicle 50 is insufficient for this. Arranged in front of the ambient heat exchanger unit 2 with regard to the longitudinal axis X is a blocking unit 7, which is illustrated in detail in FIGS. 2 and 3.

A first ambient heat exchanger 3 and a second ambient heat exchanger 4 are arranged next to one another and one above the other with regard to the vertical axis Z. The first ambient heat exchanger 3 and the second ambient heat exchanger 4 are connected together as parts of the ambient heat exchanger unit 2. However, the first ambient heat exchanger 3 and the second ambient heat exchanger 4 are fluidically separated from one another, and so a fluid flow F flows separately through the two ambient heat exchangers 3, 4.

The blocking unit 7 directly adjoins the ambient heat exchanger unit 2 on the front side with regard to the longitudinal axis X. It has a frame 8, which delimits the air flow L with regard to the transverse axis Y and with regard to the vertical axis Z. Furthermore, a partition wall 9 is arranged in a position within the frame 8, in which it defines two sub-regions 7.1, 7.2. A first sub-region 7.1 corresponds to the first ambient heat exchanger 3, while a second sub-region 7.2 corresponds to the second ambient heat exchanger 4. The partition wall 9 at least largely prevents air exchange between the two sub-regions 7.1, 7.2. The blocking unit 7 has a plurality of slat-like blocking elements 10, which are pivotable such that they can enable or block the air flow L selectively in one of the sub-regions 7.1, 7.2. FIG. 2 shows a state in which, in a first sub-region 7.1, a first partial air flow L1 is blocked by the position of the blocking elements 10, while a second partial air flow L2 in the second sub-region 7.2 can pass through passage regions 11 between the blocking elements 10 and can thus reach the second ambient heat exchanger 4. In this case, the first ambient heat exchanger 3 forms a passive ambient heat exchanger P and the second ambient heat exchanger 4 forms an active ambient heat exchanger A.

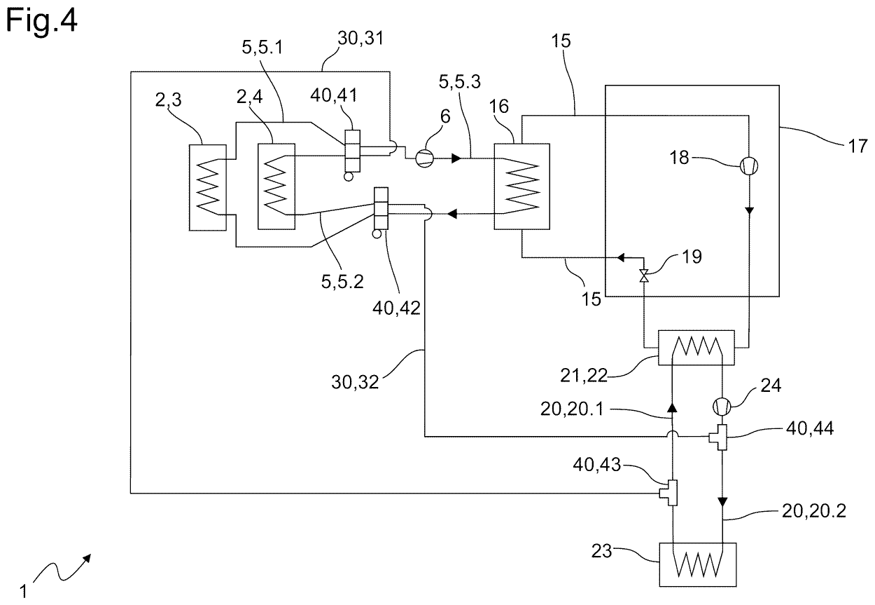

FIG. 4 shows a diagrammatic illustration of a heat transport system 1, wherein the arrangement of the individual components may, of course, differ from their actual spatial arrangement. The two ambient heat exchangers 3, 4 are fluidically connected via an ambient circuit 5 or ambient secondary circuit to a primary heat exchanger 16. The first ambient heat exchanger 3 is arranged in a first portion 5.1, the second ambient heat exchanger 4 is arranged in a second portion 5.2, and the primary heat exchanger 16 is arranged in a third portion 5.3. A frost-free aqueous mixture, for example a water-glycol mixture, can circulate in the ambient circuit 5. A primary pump unit 6 serves to maintain circulation within the ambient circuit 5 in the heating mode. A first directional valve 41 and a second directional valve 42 of a valve arrangement 40 are interposed between the first and second portion 5.1, 5.2 on one side and the third portion 5.3 on the other side. In the heating mode, said directional valves 41, 42 are set such that the first and second portion 5.1, 5.2 are connected to the primary heat exchanger 16 in parallel with one another with regard to the fluid flow.

The primary heat exchanger 16 is incorporated into a primary circuit 15, within which it forms an evaporator, while a secondary heat exchanger 22 forms a condenser. By use of a compressor 18, a working fluid is conveyed from the primary heat exchanger 16 toward the secondary heat exchanger 22, and in the process is liquefied in the region of the secondary heat exchanger 22. An expansion valve 19 arranged downstream of the secondary heat exchanger 22 ensures that the working fluid expands in the region of the primary heat exchanger 16 and can pass into a gaseous state. Therefore, it receives heat at the primary heat exchanger 16, this heat being taken from the ambient circuit 5. The compressor 18 and the expansion valve 19 belong to a heat pump system 17, which may also have a more complicated and/or different structure than the one illustrated here. In particular, the heat pump system 17 could be configured such that, in a cooling mode which is not explained in more detail here, the secondary heat exchanger 22 forms the evaporator and the primary heat exchanger 16 forms the condenser, such that heat is supplied to the ambient circuit 5.

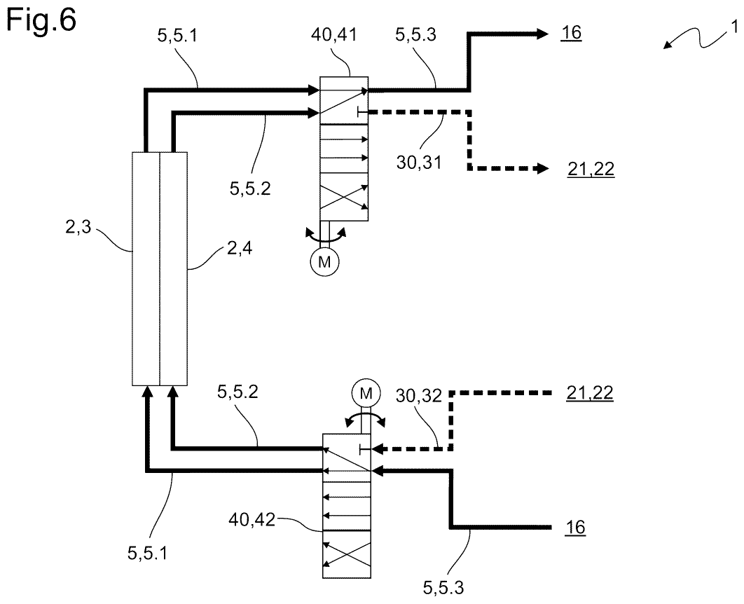

The secondary heat exchanger 22 is incorporated into a vehicle secondary circuit 20. The latter is subdivided by a third directional valve 43 and a fourth directional valve 44 into a fourth portion 20.1 with the secondary heat exchanger 22 and a fifth portion 20.2 with a heating heat exchanger 23. The vehicle secondary circuit 20 conducts a fluid, the composition of which is identical to the one in the ambient circuit 5. A secondary pump unit 24 conveys the fluid. The third directional valve 43 is connected to the first directional valve 41 by a first connecting line 31 of a connecting arrangement 30, while the fourth directional valve 44 is connected to the second directional valve 42 by a second connecting line 32 of the connecting arrangement 30. However, in the heating mode, the directional valves 41-44 are set such that the connecting lines 31, 32 are fluidically separated both from the ambient circuit 5 and from the vehicle secondary circuit 20. FIG. 6 shows the setting of the first and second directional valve 41, 42.

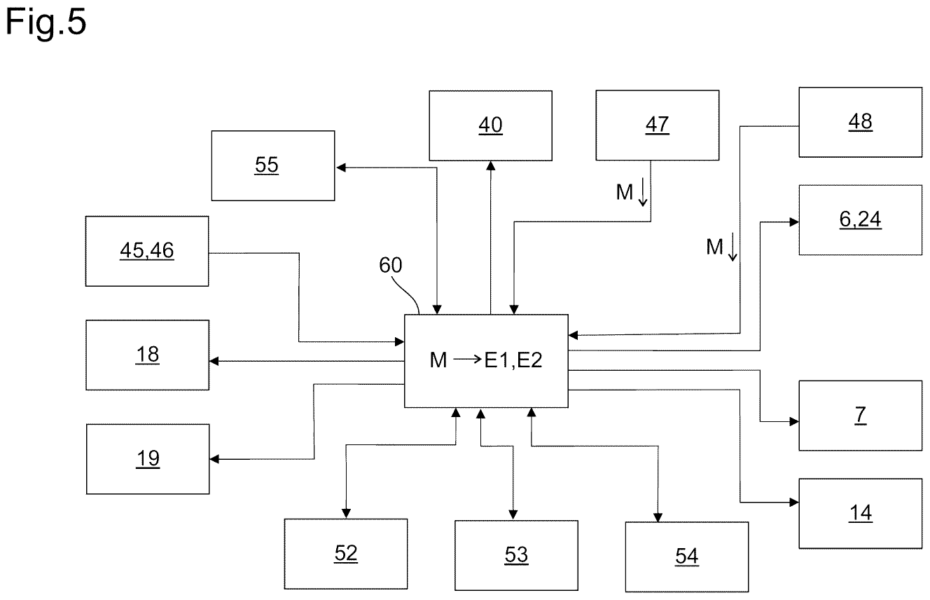

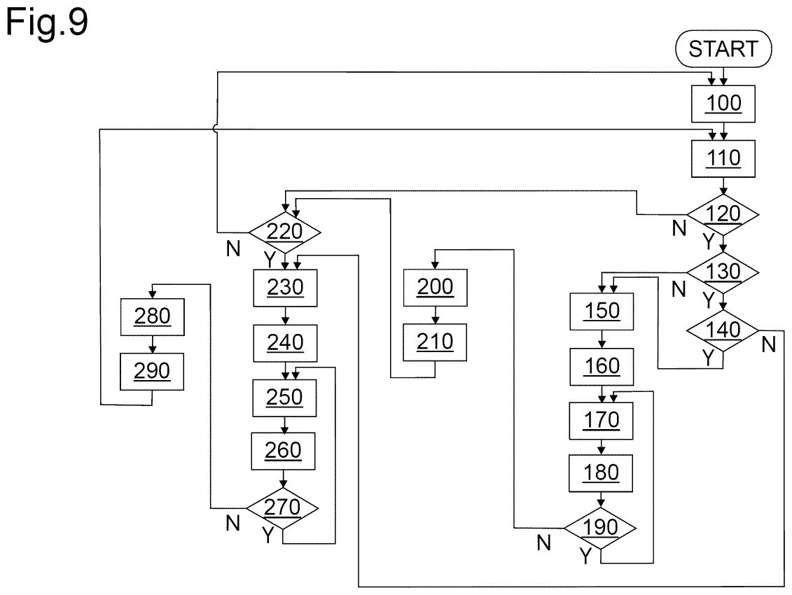

FIG. 5 is a block diagram of components of the vehicle 50 and of transmission paths between them. A system control unit 60 of the heat transfer system 1 is connected in a signal-transmitting manner to the pump units 6, 24 of the valve arrangement 40, to the compressor 18, to the expansion valve 19, to the blocking unit 7 and to the fan unit 14, in order to actuate these. Furthermore, the system control unit 60 is connected to various sensors 45-48. These are pressure sensors 45 and temperature sensors 46, which are assigned to the primary circuit 15, an ambient temperature sensor 47, by which an ambient temperature is able to be measured, and fluid temperature sensors 48, by which a temperature of the fluid flow F is able to be measured immediately downstream of each of the two ambient heat exchangers 3, 4. The ambient temperature and the fluid temperature represent measurement values M that the control system unit 60 receives. Based on these measurement values M, it can determine icing indices E1, E2, as will be explained in the following text. Furthermore, the system control unit 60 is connected to a climate control system 52 for the vehicle interior 51, to a battery control module 53, to a power-electronics control module 54, and to a drive-system control module 55 of the vehicle 50, in each case in a bidirectionally signal-transmitting manner. The system control unit 60 is designed to control the heat transport system 1 and to carry out a method that is described below with reference to FIG. 9.

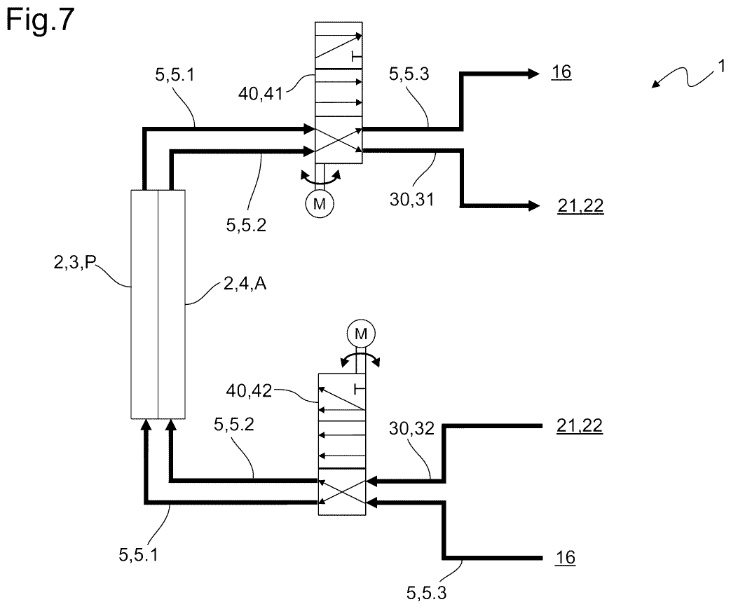

At particularly low ambient temperatures, one or both of the ambient heat exchangers 3, 4 may ice up. In order to counteract this, the heat transport system 1 may change into a de-icing mode, wherein the change is controlled by the system control unit 60. FIG. 7 shows a first de-icing mode, which serves to de-ice the first ambient heat exchanger 3. As a result of the setting of the first and second directional valve 41, 42, the connection between the first portion 5.1 and the third portion 5.3 is interrupted, with the result that the first ambient heat exchanger 3 is fluidically separated from the primary heat exchanger 16. It thus forms a passive ambient heat exchanger P. The connection between the second portion 5.2 and the third portion 5.3 still exists, however, such that the second ambient heat exchanger 4 is still fluidically connected to the primary heat exchanger 16 and thus forms an active ambient heat exchanger A. In order to prevent the first ambient heat exchanger 3 from being cooled down by the air flow L, the blocking unit 7 is set as shown in FIG. 2 in order to block the first partial air flow L1. Furthermore, the first portion 5.1 is fluidically connected via the first and second directional valve 41, 42 to the connecting lines 31, 32. The latter are in turn fluidically connected via the third and fourth directional valve 43, 44 to the vehicle secondary circuit 20. Thus, the first ambient heat exchanger 3 is effectively incorporated into the vehicle secondary circuit 20 and arranged parallel to the heating heat exchanger 23 with regard to the fluid flow. In this case, the secondary heat exchanger 22 forms a heat source 21, from which the first ambient heat exchanger 3 is supplied with heat via the conveyed fluid. As a result, de-icing is substantially enhanced or, depending on the ambient temperature, is allowed in the first place.

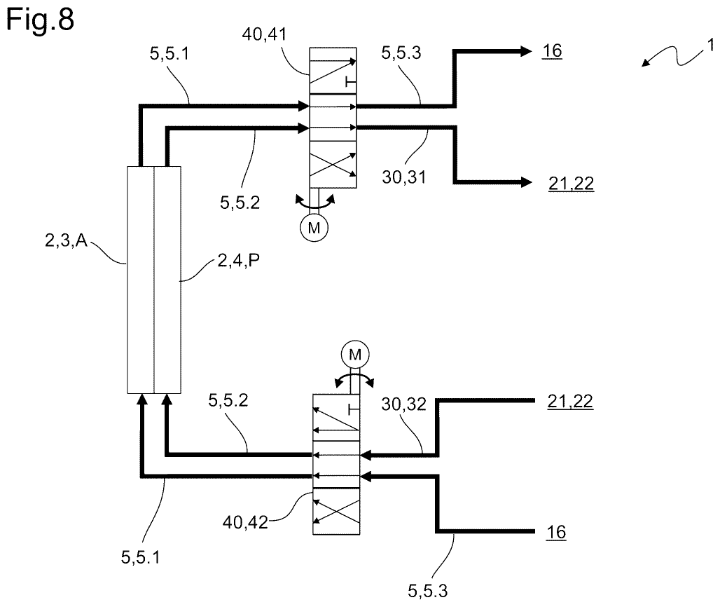

While the first ambient heat exchanger is being de-iced, the second ambient heat exchanger 4 remains active, and this in turn can result in the latter icing up. In order to counteract this, the heat transport system 1 can be transferred into a second de-icing mode, which is illustrated in FIG. 8. In this case, the two ambient heat exchangers 3, 4 switch roles compared with the first de-icing mode. The first ambient heat exchanger 3 now forms the active ambient heat exchanger A, while the second ambient heat exchanger 4 forms the passive ambient heat exchanger P. By use of the first and second directional valve 41, 42, the second portion 5.2, including the second ambient heat exchanger 4, is fluidically connected to the connecting lines 31, 32. It can thus receive heat from the heat source 21 formed by the secondary heat exchanger 22. The blocking unit 7 is adjusted such that the first partial air flow L1 is enabled, while the second partial air flow L2 is blocked.

In a simplified configuration, the third and fourth directional valve 43, 44 could also be omitted and each be replaced by a simple branch. In this case, the different operating modes can be set only by changing over the first and second directional valve 41, 42. In other words, the two connecting lines 31, 32 are in this case enabled or blocked depending on the setting of the first two directional valves 41, 42, while they are permanently open toward the vehicle secondary circuit.

In another contemplated configuration, the first and second directional valve 41, 42, instead of a simple blocking and enabling function, could also have a setting function such that, for example, the fluidic connection of the passive ambient heat exchanger P to the primary heat exchanger 16 is not fully interrupted, but is only reduced.

FIG. 9 is a flow chart of a method that can be carried out by the heat transport system 1 in FIG. 1, wherein the method is controlled by the system control unit 60. Stored in the system control unit 60 is a de-icing criterion, on the basis of which the system control unit 60 can identify a need for de-icing of the ambient heat exchangers 3, 4, can select one of the ambient heat exchangers 3, 4 as a passive ambient heat exchanger P, and can transfer the heat transport system 1 into a de-icing mode. After the start, the heat transport system 1 is first of all operated in the heating mode. To this end, in a step 100, the valve arrangement 40 is set as per FIG. 6. Furthermore, in a step 110, a first icing index E1 of the first ambient heat exchanger 3 and a second icing index E2 are determined. The icing index E1, E2 may in this case be the fluid temperature difference T_{FD} between a fluid temperature T_{F} detected by the respective fluid temperature sensor 48 and the ambient temperature T_{U} detected by the ambient temperature sensor 47, i.e. E1=T_{FD1} and E2=T_{FD2}.

In a step 120, the system control unit 60 checks whether there is a need for de-icing of the first ambient heat exchanger 3. To this end, it compares the first icing index E1 with a predefined comparative value. If the fluid temperature difference T_{FD1} lies too far in the negative range, this indicates icing up. The following inequality can serve as a criterion for icing up:

E1=T_{FD1}<T_{V}

If the inequality is satisfied, such that the first icing index E1 is lower than the comparative value TV, the system control unit 60 identifies therefrom a need for de-icing of the first ambient heat exchanger 3 and continues with a step 130. Therein, the second icing index E2 of the second ambient heat exchanger 4 is compared with a predefined comparative value which may be identical to or differ from the comparative value TV for the first ambient heat exchanger 3. In this case, the following inequality can be checked:

E1=T_{FD2}<T_{V}

If the icing index E2 is lower than the comparative value, the system control unit 60 identifies therefrom a need for de-icing of the second ambient heat exchanger 4 and continues with a step 140. In this step, the two icing indices E1, E2 are compared with one another. If the first icing index E1 is lower, the first ambient heat exchanger 3 is selected as a passive heat exchanger P. The first ambient heat exchanger 3 is also selected as a passive heat exchanger P if no need for de-icing of the second ambient heat exchanger 4 is established in step 130. In both cases, the system control unit 60 transfers the heat transport system 1 into the first de-icing mode.

The method continues with a step 150, in which the blocking unit 7 is set as shown in FIG. 2 in order to block the first partial air flow L1. In a subsequent step 160, the valve arrangement 40 is changed over by the system control unit 60 as illustrated in FIG. 7. In other words, the first ambient heat exchanger 3 is fluidically connected to the heat source 21 while the second ambient heat exchanger 4 remains connected to the primary heat exchanger 16. In a step 170, the heat transfer system 1 is operated with the described settings for a certain period of time (for example a few seconds) before, in 180, the first icing index E1 is updated and, in step 190, a new check is carried out as to whether the first ambient heat exchanger 3 continues to have a need for de-icing. If there is still a need for de-icing, the method returns to step 170. By contrast, if there is no longer a need for de-icing, the system control unit 60 transfers the heat transport system 1 back into the heating mode. In other words, the first ambient heat exchanger 3 is now operated further as an active ambient heat exchanger A, wherein the method continues with a step 200. In this step, the blocking unit 7 is completely opened in order to allow both partial air flows L1, L2 to pass through. In a subsequent step 210, the valve arrangement 40 is set by the system control unit 60 as per FIG. 6, i.e. both ambient heat exchangers 3, 4 are connected to the primary heat exchanger 16.

In a step 220, the second icing index E2 of the second ambient heat exchanger 4 is again compared with the predefined comparative value. Step 220 is also carried out when no need for de-icing of the first ambient heat exchanger 3 has been identified in step 120. If the second icing index E2 is lower than the comparative value, the system control unit 60 identifies therefrom a need for de-icing of the second ambient heat exchanger 4, selects it as a passive ambient heat exchanger P, and continues with step 230. This is also the case if it has been established in step 140 that the first icing index E1 is not lower than the second icing index E2. In step 230, the blocking unit 7 is adjusted in order to block the second partial air flow L2. In a subsequent step 240, the valve arrangement 40 is set by the system control unit 60 as per FIG. 8. In other words, the second ambient heat exchanger 4 is fluidically connected to the heat source 21 while the first ambient heat exchanger 3 remains connected to the primary heat exchanger 16.

In a step 250, the heat transfer system 1 is operated with the described settings for a certain period of time (for example a few seconds). In step 260, the second icing index E2 is updated before, in 270, a re-check takes place as to whether the second ambient heat exchanger 4 still has a need for de-icing. If there is still a need for de-icing, the method returns to step 250. By contrast, if there is no longer a need for de-icing, the system control unit 60 transfers the heat transport system 1 back into the heating mode, wherein the method continues with a step 280. In this step, the blocking unit 7 is completely opened in order to allow both partial air flows L1, L2 to pass through. In a subsequent step 290, the valve arrangement 40 is set by the system control unit 60 as per FIG. 6, i.e. both ambient heat exchangers 3, 4 are connected to the primary heat exchanger 16. Subsequently, the method returns to step 110.

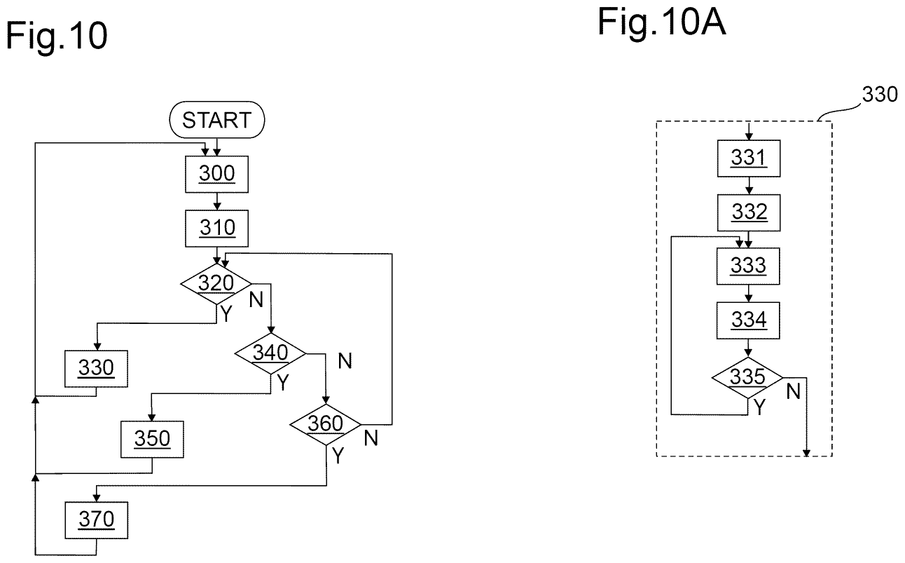

FIGS. 10 and 10A illustrate a method that can be carried out with a heat transfer system 1 (not illustrated here) which, instead of two ambient heat exchangers 3, 4, has a total of three ambient heat exchangers. Such a heat transfer system 1 differs in particular from the one illustrated in FIGS. 1-8 in that the first and second directional valve 41, 42 each have, on one side, two ports for connecting to the primary heat exchanger 16 and to the heat source 21 and, on the other side, three ports for connecting to each of the three ambient heat exchangers, for a total of five ports. Furthermore, each directional valve 41, 42 has to effect a total of four switching states. In this way, the heating mode and three different de-icing modes can be realized. In each of the de-icing modes, one of the ambient heat exchangers is connected to the heat source 21, while the other two are connected to the primary heat exchanger 16.

After the start, in a step 300, the valve arrangement 40 is set as per the heating mode such that all the ambient heat exchangers are connected to the primary heat exchanger. In a further step 310, the blocking unit 7 is set such that it enables the partial air flows to all the ambient heat exchangers. In a step 320, the system control unit 60 checks whether there is a need for de-icing of the first ambient heat exchanger. If there is, the first ambient heat exchanger is selected as a passive ambient heat exchanger P and in a block 330, de-icing of the first ambient heat exchanger is carried out before the method returns to step 300. If the check in step 320 has a negative result, a check is made in a step 340 as to whether there is a need for de-icing of the second ambient heat exchanger. If there is, the second ambient heat exchanger is selected as a passive ambient heat exchanger P and in a block 350, de-icing of the second ambient heat exchanger is carried out before the method returns to step 300. If the check in step 340 has a negative result, a check is made in a step 360 as to whether there is a need for de-icing of the third ambient heat exchanger. If there is, the third ambient heat exchanger is selected as a passive ambient heat exchanger P and in a block 370, de-icing of the third ambient heat exchanger is carried out before the method returns to step 300. If the check in step 360 has a negative result, the method returns directly to step 320.

The individual steps of block 330 are illustrated in FIG. 10A. The blocks 350 and 370 contain corresponding steps. In a step 331, the blocking unit 7 is set such that it blocks the partial air flow to the first ambient heat exchanger. In a step 332, the valve arrangement 40 is set such that the first ambient heat exchanger is connected to the heat source 21 while the second and third ambient heat exchangers remain connected to the primary heat exchanger 16. In a step 333, the heat transfer system 1 is operated with the described settings for a certain period of time (for example a few seconds) before, in step 334, the first icing index E1 is updated and, in step 335, a new check is carried out as to whether the first ambient heat exchanger continues to have a need for de-icing. If it does, the method returns to step 333. Otherwise, the block 330 ends.

While, in the method according to FIG. 9, the selection of the passive ambient heat exchanger is undertaken on the basis of the icing indices E1, E2, it is undertaken in this method on the basis of a defined prioritization of the three ambient heat exchangers, according to which the first ambient heat exchanger has priority over the second and the latter in turn has priority over the third.

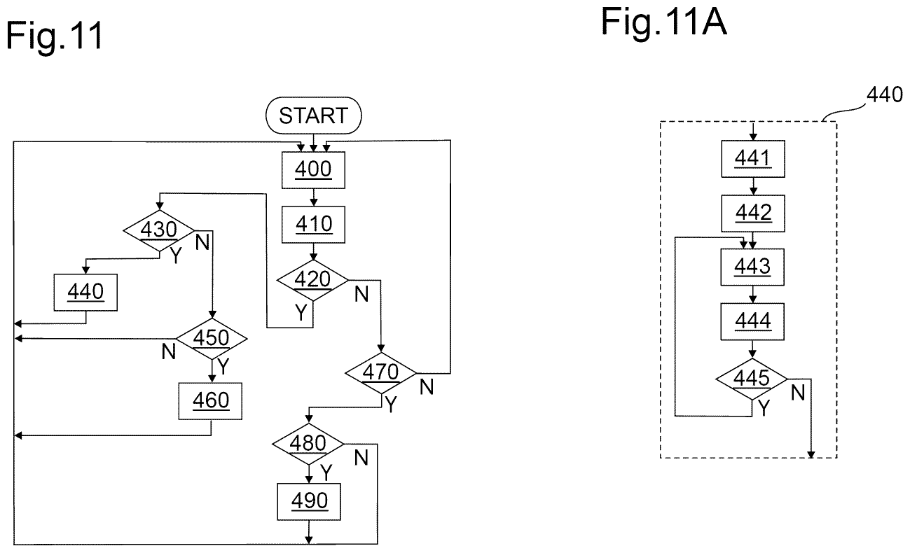

FIGS. 11 and 11A illustrate a method that can be carried out with a heat transfer system 1 (not illustrated here) which again has three ambient heat exchangers. In this case too, the first and second directional valve 41, 42 each have, on one side, two ports for connecting to the primary heat exchanger 16 and to the heat source 21 and, on the other side, three ports for connecting to each of the three ambient heat exchangers. Here too, each directional valve 41, 42 has to effect a total of four switching states with which the heating mode and three different de-icing modes can be realized. In contrast to the example according to FIGS. 10 and 10A, however, in each of the de-icing modes, two ambient heat exchangers are connected to the heat source 21, while the remaining ambient heat exchanger is connected to the primary heat exchanger 16.

After the start, in a step 400, the valve arrangement 40 is set as per the heating mode such that all the ambient heat exchangers are connected to the primary heat exchanger. In a further step 410, the blocking unit 7 is set such that it enables the partial air flows to all the ambient heat exchangers. In a step 420, the system control unit 60 checks whether there is a need for de-icing of the first ambient heat exchanger. If there is, a check is made in a step 430 as to whether there is a need for de-icing of the second ambient heat exchanger. If this is also the case, the first and second ambient heat exchangers are selected as passive ambient heat exchangers P and in a block 440, de-icing of these ambient heat exchangers is carried out before the method returns to step 400. If the check in step 430 has a negative result, a check is made in a step 450 as to whether there is a need for de-icing of the third ambient heat exchanger. If there is, the first and third ambient heat exchangers are selected as passive ambient heat exchangers P and in a block 460, de-icing of these ambient heat exchangers is carried out before the method returns to step 400. If the check in step 450 has a negative result, the method returns to step 400. If the check in step 420 has a negative result, a check is made in a step 470 as to whether there is a need for de-icing of the second ambient heat exchanger. If there is not, the method returns to step 400. If there is, a check is made in a step 480 as to whether there is a need for de-icing of the third ambient heat exchanger. If this is the case, the second and third ambient heat exchangers are selected as passive ambient heat exchangers P and in a block 490, de-icing of these two ambient heat exchangers is carried out before the method returns to step 400. If the check in step 480 has a negative result, the method returns directly to step 400.

The individual steps of block 440 are illustrated in FIG. 11A. The blocks 460 and 490 contain corresponding steps. In a step 441, the blocking unit 7 is set such that it blocks the partial air flows to the first and second ambient heat exchanger. In a step 442, the valve arrangement 40 is set such that the first and second ambient heat exchangers are connected to the heat source 21 while the third ambient heat exchanger remains connected to the primary heat exchanger 16. In a step 443, the heat transfer system 1 is operated with the described settings for a certain period of time (for example a few seconds) before, in step 444, the icing indices E1, E2 are updated and, in step 445, a new check is carried out as to whether both the first ambient heat exchanger and the second ambient heat exchanger continue to have a need for de-icing. If they do, the method returns to step 443. Otherwise, the block 440 ends.

While, in the method according to FIG. 9, the selection of the passive ambient heat exchanger is undertaken on the basis of the icing indices E1, E2, it is undertaken in this method on the basis of a defined prioritization of the three ambient heat exchangers, according to which the first ambient heat exchanger has priority over the second and the latter in turn has priority over the third.

The disclosure provides a heat transport system for a vehicle. The heat transport system is intended normally for a road vehicle, in particular a motor vehicle, for example a bus, truck or passenger car. However, it would also be conceivable to use it, for example, in rail vehicles or watercraft, and also to use it in a vehicle which does not have its own drive, for example a trailer. Advantageously, the heat transport system can be intended for an electric vehicle. In this case, the term “electric vehicle” means a vehicle that has at least one electric motor that serves for driving the vehicle. In particular, the vehicle may be a purely electrically powered vehicle, but this does not preclude the use of the disclosure in hybrid vehicles. The term “heat transport system” generally means that at least some components of the heat transport system are at least periodically used for heat transport. In turn, this heat transport can serve for the temperature control of zones or components of the vehicle. In this context, “temperature control” means the targeted influencing of a temperature, in particular in order to keep this temperature within a specified range or to bring it into such a range. It is also possible for components that are at least not directly used for temperature control or heat transport to be regarded as part of the heat transport system. This relates, inter alia, to components which are temperature-controlled, and to components which control the actual “active” components or support the functioning thereof. In particular, the heat transport system can be provided for the temperature control of a vehicle interior and may, in this case, also be referred to as an air-conditioning system.

The heat transport system has a plurality of ambient heat exchangers, each of which is designed for heat exchange with an air flow and, in a heating mode of the heat transport system, is fluidically connected via an ambient circuit to a primary heat exchanger by which heat is able to be supplied or is supplied at least indirectly to a vehicle zone. For effective implementation of the disclosure, two ambient heat exchangers are sufficient, but any desired larger number may also be provided. Each of the ambient heat exchangers is designed for heat exchange with an air flow. Although the present text refers to “an” air flow, the air flow may consist of a plurality of partial air flows, which may be at least partially separated from one another. The air flow may be able to be created in full or part by a driving movement of the vehicle. Advantageously, a motor-drivable or motor-driven fan unit is provided, which is designed to create all or part of the air flow. The fan unit may be considered to be part of the heat transport system. The air flow may flow into each of the ambient heat exchangers, with the result that heat exchange between the air flow and a fluid guided in the ambient heat exchanger is possible. In a manner known in principle, each ambient heat exchanger can have a perforated, in particular lattice-like structure, such that the air flow can flow through it. The term “ambient heat exchanger” should not be interpreted as being limiting. However, it does indicate that the air flow is preferably ambient air that originates from the surroundings of the vehicle. At least one ambient heat exchanger can be installed at the front of the vehicle with regard to a vehicle longitudinal axis, in order to achieve optimal inflow. However, other installation positions are also conceivable.

In the heating mode of the heat transport system, each ambient heat exchanger is fluidically connected via an ambient circuit to a primary heat exchanger. Here and in the following text, “fluidically connected” means that the connection is such that fluid can be guided from one component to the other. It is also possible to say that fluidically connected components are connected in a fluid-conducting manner. The ambient circuit is a fluid circuit within which the same fluid is received as in the ambient heat exchangers. The fluid provided may be a frost-free aqueous mixture, for example a water-glycol mixture. The ambient circuit may have suitable lines which connect the ambient heat exchanger to the primary heat exchanger. Furthermore, it may have an ambient pump unit, which is designed to convey the fluid within the ambient circuit. In the heating mode, all the ambient heat exchangers may be connected to the primary heat exchanger in parallel with one another with regard to the fluid flow. In other words, the fluid flow passing through the primary heat exchanger may be split between the individual ambient heat exchangers and combined again after passing through same. Although the present text refers to “a” primary heat exchanger, embodiments in which the ambient circuit has a plurality of primary heat exchangers are conceivable. The term “primary heat exchanger” serves only for terminological differentiation and should not be interpreted as being limiting in any way with regard to the design or arrangement of this heat exchanger. Nor does the designation imply that there has to be, for example, a secondary heat exchanger. By use of the (at least one) primary heat exchanger, heat is able to be supplied at least indirectly to a vehicle zone. The vehicle zone may be, in particular, a vehicle interior or part thereof, but could also be some other vehicle component, for example a vehicle battery. The primary heat exchanger may be in direct thermal contact with the vehicle zone. In other embodiments, the primary heat exchanger may also be designed for heat exchange between the fluid in the ambient circuit and a fluid in a further circuit, wherein the heat is able to be supplied to the vehicle zone via the further circuit. Preferably, the supply of heat to the vehicle zone is based on the heat pump principle. This does not necessarily mean, however, that the ambient circuit has to be in the form of a heat pump circuit.

Furthermore, the heat transport system has a system control unit, which is designed to apply a de-icing criterion in order to establish a need for de-icing in at least one of the ambient heat exchangers, to select the latter as a passive ambient heat exchanger and to transfer the heat transport system into a de-icing mode. The system control unit may also be referred to as a system controller. Some functions of the system control unit may be implemented by software. It is designed to apply the abovementioned de-icing criterion, which represents the decision-making basis for different actions. The de-icing criterion may be more or less complex. In some embodiments, it may contain a plurality of sub-criteria. Alternatively, it also possible that at least one de-icing criterion is used, and a plurality of de-icing criteria in some embodiments. By way of simplification, the following text refers to “a” or “the” de-icing criterion. Based on the de-icing criterion, the system control unit can establish whether there is a need for de-icing in at least one of the ambient heat exchangers. There is a need for de-icing in particular when the ambient heat exchanger externally has or could potentially have a layer of ice. This may be because, at particularly low external temperatures (for example 5 °C or less), heat continues to be taken from the air flow by the heating mode, with the result that the temperature decreases even further in the region of the surface of the ambient heat exchanger. A layer of ice that is present even only in certain regions significantly impairs the efficiency of the ambient heat exchanger. Depending on the type of de-icing criterion, it is possible for the system control unit to identify a need for de-icing even though the corresponding ambient heat exchanger does not (yet) have a layer of ice. In this regard, the identification of the need for de-icing should not be equated in each case with the actual existence of icing.

Furthermore, the system control unit, likewise on the basis of the de-icing criterion, can select the ambient heat exchanger as a passive ambient heat exchanger. It is possible for a plurality of passive ambient heat exchangers to be selected. A need for de-icing has to have been identified for each of these ambient heat exchangers. On the other hand, it is not necessary for each ambient heat exchanger in which a need for de-icing has been identified to be selected as a passive ambient heat exchanger. Furthermore, the system control unit can transfer the heat transport system into a de-icing mode. This de-icing mode presumes the selection of at least one passive ambient heat exchanger. Conversely, it would be conceivable, however, for the heat transport system to remain in the heating mode even after the selection of one or more passive ambient heat exchangers. This may be the case, for example, when the de-icing criterion, in spite of the selection of the passive ambient heat exchanger, includes yet another condition that has not been met. With regard to the abovementioned sub-criteria, the de-icing criterion could contain a first sub-criterion, on the basis of which the need for de-icing is identified, a second sub-criterion, on the basis of which the at least one passive ambient heat exchanger is selected, and a third sub-criterion, on the basis of which a decision is made as to whether the heat transport system is transferred into the de-icing mode. Where “the” de-icing mode is referred to by way of simplification in the following text, it is expressly possible for the heat transport system to be designed for a plurality of de-icing modes. These may differ in particular with regard to which ambient heat exchangers are selected as passive ambient heat exchangers.

In the de-icing mode, at least one active ambient heat exchanger is fluidically connected to the primary heat exchanger, while fluid exchange between the at least one passive ambient heat exchanger and the primary heat exchanger is at least restricted compared with the heating mode. The de-icing mode is a mode of the heat transport system that differs from the heating mode. The de-icing mode is provided in particular for a situation in which at least one of the ambient heat exchangers externally has or potentially could have a layer of ice. As explained above, a layer of ice that is present even only in certain regions significantly impairs the efficiency of the ambient heat exchanger. It therefore has to be removed, and this is intended to be achieved by the de-icing mode. This may, for example, also be referred to as a defrosting mode. Further heat transfer from the ambient heat exchanger to the primary heat exchanger obstructs the aim of de-icing. Therefore, the fluid exchange between the at least one passive ambient heat exchanger and the primary heat exchanger is at least restricted compared with the heating mode. In other words, the fluid exchange between the passive ambient heat exchanger and the primary heat exchanger is lower in the de-icing mode than in the heating mode. In particular, the fluid exchange can also be reduced to zero. Further heat delivery from the ambient heat exchanger to the primary heat exchanger is thus reduced or entirely prevented. In some embodiments, this may suffice by itself to sufficiently increase the temperature of the passive ambient heat exchanger after some time, for example on account of heat transfer from other, hotter vehicle components. In other embodiments, additional measures may also need to be taken, which will be explained in the following text.

The at least one ambient heat exchanger that is operated as a passive ambient heat exchanger makes no contribution or only a negligible contribution to the heat transfer to the primary heat exchanger. In order nevertheless to allow the vehicle zone to be heated, in the de-icing mode at least one ambient heat exchanger is operated as an active ambient heat exchanger. This is fluidically connected to the primary heat exchanger, wherein preferably no reduction in fluid exchange with the primary heat exchanger is provided compared with the heating mode. The fluidic connection may preferably, as in the heating mode, be provided via the ambient circuit. The fluid exchange could even be enhanced compared with the heating mode. Even though the fluid exchange of the at least one active ambient heat exchanger with the primary heat exchanger is reduced compared with the heating mode, this is the case even more so for the fluid exchange of the at least one passive ambient heat exchanger. Put another way, the fluid exchange of the at least one passive ambient heat exchanger with the primary heat exchanger is reduced at least in relation to the fluid exchange of the at least one active ambient heat exchanger with the primary heat exchanger. In any event, this has the result that the fluid exchange of the primary heat exchanger in the de-icing mode takes place primarily or only with the at least one active ambient heat exchanger. The corresponding fluid exchange ensures that, via the active ambient heat exchanger, heat can still be taken from the air flow and supplied to the primary heat exchanger. Thus, even during the de-icing of the passive ambient heat exchanger, it is possible to heat the vehicle zone, this being based at least partially, in an effective manner in terms of energy, on heat extraction from the ambient air.

The heat transport system may have a valve arrangement which, for its part, may have at least one valve or a plurality of valves. The valve arrangement may be actuated or actuable by the system control unit, such that the system control unit can adjust the heat transport system between the heating mode and the de-icing mode by adjusting the valve arrangement.

As mentioned above, it is conceivable for fluid exchange to still be possible (although reduced) between a passive ambient heat exchanger and the primary heat exchanger even in the de-icing mode. However, the at least one passive ambient heat exchanger may be fluidically separated from the primary heat exchanger in the de-icing mode. In other words, any fluid exchange between the heat exchangers via the ambient circuit is prevented. The abovementioned valve arrangement may, for this purpose, have in particular at least one check valve and/or a directional valve. Complete fluidic separation prevents heat from being discharged from the passive ambient heat exchanger to the primary heat exchanger by the fluid.

Advantageously, the heat transport system is designed for a plurality of de-icing modes, wherein each of the ambient heat exchangers is able to be operated passively in at least one de-icing mode. The different de-icing modes may also be regarded as sub-modes of a single de-icing mode. A variety of different configurations are conceivable, for example one de-icing mode for each ambient heat exchanger. In this case, in each case one ambient heat exchanger could be operated passively, while all the remaining ambient heat exchangers are operated actively. Another possibility would consist in providing exactly two de-icing modes, which are assigned to two groups, regardless of the number of ambient heat exchangers. In one de-icing mode, the first group can be operated passively and the second group actively, while in the other de-icing mode, the first group is operated actively and the second group passively. In addition, a large number of further configurations are conceivable. In any event, in this embodiment, it is ensured that each of the ambient heat exchangers can be de-iced as required. If the ambient heat exchangers are operated under similar conditions, in particular have the air flow flowing into them in a similar way, there is a similar probability of icing up for each ambient heat exchanger. In this case, different de-icing modes can be set successively or in a temporally alternating manner, by which each heat exchanger is periodically de-iced and can subsequently be operated actively again. The heat exchangers can thus be alternately de-iced.

Although the present text refers to a plurality of ambient heat exchangers which are operated differently in the de-icing mode, this says nothing about the spatial arrangement or spatial separation of the ambient heat exchangers. The ambient heat exchangers can be spatially separated and optionally even be arranged in different zones of the vehicle. According to one configuration, the heat transport system has an ambient heat exchanger unit having a plurality of ambient heat exchangers that are arranged adjacently to one another. Alternatively, the ambient heat exchanger unit could also be regarded as a single heat exchanger and the individual ambient heat exchangers as heat exchanger portions. In any event, in this embodiment of the disclosure, the ambient heat exchangers are adjacent to one another and could, in particular, be connected together. However, they may be offset with respect to one another transversely to an air-flow direction of the air flow. This prevents the air flow from flowing successively through two ambient heat exchangers. Instead, a separate partial air flow flows through each of the ambient heat exchangers. In this case, the ambient heat exchangers may, for example, be offset with respect to one another transversely to a vehicle longitudinal axis, since the vehicle longitudinal axis can correspond at least approximately to an air-flow direction. In addition or as an alternative to an adjacent arrangement of ambient heat exchangers, it is also possible, however, for at least two ambient heat exchangers to be substantially spaced apart spatially, for example by at least 50% or at least 100% of a greatest extension of the larger of the two heat exchangers.

Advantageously, the primary heat exchanger is fluidically connected to a secondary heat exchanger by a primary circuit, wherein, in the heating mode, heat is transferable or transferred from the primary heat exchanger to the vehicle zone via the secondary heat exchanger, and wherein the ambient circuit forms an ambient secondary circuit. The term “primary circuit” should not be interpreted as meaning that there has to be a further circuit in addition to the primary circuit and the ambient circuit. In the heating mode, the primary circuit takes heat from the ambient circuit, wherein the heat transfer takes place via the primary heat exchanger. On the other hand, the primary circuit discharges heat via the secondary heat exchanger, wither directly to the vehicle zone or indirectly, via interposed heat-transfer means. The primary circuit may be fluidically separated from the ambient circuit in every operating mode of the heat transport system. In particular, it is also possible for different fluids to be provided in the primary circuit and in the ambient circuit. In this embodiment, the ambient circuit forms an ambient secondary circuit, which is assigned to the primary circuit. It is possible to say that the primary circuit can receive heat from the surroundings via the ambient secondary circuit.

In one configuration, the primary circuit is in the form of a heat pump circuit and has a compressor and an expansion valve. The primary circuit thus functions according to the heat pump principle. In this case, in the heating mode, heat is conveyed from the primary heat exchanger to the secondary heat exchanger, wherein the conveying of heat is driven by the compressor. The compressor is motor-drivable and may, in particular, be electrically drivable. In the activated state, it generates a fluid flow within the primary circuit. Overall, the generated fluid flow is self-contained, such that it forms a fluid circuit. In the operating state, the fluid may be partially liquid and partially gaseous. The fluid in the primary circuit may also be referred to as a working fluid or as a refrigerant. In addition to delivering the fluid, the compressor is also used to generate a pressure difference and a temperature difference.

The primary heat exchanger is preferably fluidically connected to the secondary heat exchanger upstream via the expansion valve. The terms “upstream” and “downstream” refer to the direction of the fluid flow provided in the heating mode. In this case, this means that the fluid flows from the secondary heat exchanger, through the expansion valve, to the primary heat exchanger. It goes without saying that the connection between the secondary heat exchanger and the first expansion valve and the connection between the latter and the primary heat exchanger can be direct or indirect, i.e. in particular at least one fluid-conducting line can be interposed. In the operating state, at least a part of the fluid flow from the secondary heat exchanger passes via the expansion valve to the primary heat exchanger and onward via the compressor back to the secondary heat exchanger. The latter takes place bypassing the expansion valve, i.e. the fluid does not flow through the latter on its way from the primary heat exchanger to the secondary heat exchanger. The expansion valve, together with the compressor, serves to establish a pressure difference, wherein the primary heat exchanger is arranged on a low-pressure side and the secondary heat exchanger is arranged on a high-pressure side. The primary heat exchanger can act as an evaporator, while the secondary heat exchanger acts as a condenser. Thus, in the heating mode, heat can be discharged, via the secondary heat exchanger, directly or indirectly to the at least one vehicle zone to be heated.

The secondary heat exchanger could be in direct thermal contact with the vehicle zone. According to another embodiment, the secondary heat exchanger is fluidically connected via a vehicle secondary circuit to a heating heat exchanger which is assigned to the vehicle zone. In other words, the heating heat exchanger is designed to transfer heat to the vehicle zone. It can be arranged in the vehicle zone or directly adjoining the vehicle zone. The heating heat exchanger may be assigned a fan, by which heated air is blown into the vehicle zone. The vehicle secondary circuit can receive heat from the primary circuit via the secondary heat exchanger. The vehicle secondary circuit is a fluid circuit within which the same fluid is received as in a region of the secondary heat exchanger that is fluidically separated from the primary circuit. Here too, the fluid provided may be a frost-free aqueous mixture, for example a water-glycol mixture. The fluid in the vehicle secondary circuit may, in particular, have an identical composition to the fluid in the ambient circuit. The vehicle secondary circuit may have suitable lines which connect the secondary heat exchanger to the heating heat exchanger. Furthermore, it may have a vehicle pump unit, which is designed to convey the fluid within the vehicle secondary circuit.

As mentioned above, separation of the passive ambient heat exchanger from the primary heat exchanger is potentially insufficient for bringing about effective de-icing. In the de-icing mode, the at least one passive ambient heat exchanger may be fluidically connected via a connecting arrangement to at least one heat source. The heat source may be any desired object or any desired region from which it is possible to extract heat, which can be transferred to the passive ambient heat exchanger. For example, the heat source may have a higher temperature than the passive ambient heat exchanger and/or than the ambient temperature. Advantageously, the temperature of the heat source is at least above 0 °C, wherein higher temperatures facilitate effective use of the heat source. In particular, a heat source may be in contact with a vehicle component from which excess heat has to be discharged, for example a drive motor, power electronics, a battery or the like. The heat source may be a heat exchanger which is thermal contact with the corresponding component. The connecting arrangement has suitable lines, by which a fluidic connection is able to be established between the heat source and the ambient heat exchanger. As a result of the heat being supplied from the heat source, the de-icing process may be made much quicker. Potentially, this also makes the de-icing process possible in the first place, in particular in the case of particularly low ambient temperatures. If the passive ambient heat exchanger is fluidically separated from the primary heat exchanger, it is possible, in the de-icing mode, for it to be flowed through entirely by fluid that is supplied via the connecting arrangement. If there is still a partial connection to the primary heat exchanger, the passive ambient heat exchanger is flowed through partially by fluid from the primary heat exchanger and partially by fluid from the heat source. In any event, the connecting arrangement may conduct a fluid having an identical composition to that in the ambient circuit. In the heating mode, each ambient heat exchanger may be fluidically separated from the connecting arrangement. The connecting arrangement has at least one additional element compared with the ambient circuit and (if present) the vehicle secondary circuit. In some embodiments, however, it may also be formed partially by the ambient circuit and/or the vehicle secondary circuit. It goes without saying that a pump unit may be designed to convey fluid between the heat source and the passive ambient heat exchanger. In some embodiments, this may be an additional pump unit, but in other embodiments, it may also be the abovementioned vehicle pump unit or the ambient pump unit.

In one configuration, in the de-icing mode, the at least one passive ambient heat exchanger is fluidically connected via the connecting arrangement to the vehicle secondary circuit. It is also possible to say that the passive ambient heat exchanger is fluidically incorporated into the vehicle secondary circuit. In any event, relatively hot fluid is supplied to the passive ambient heat exchanger from the vehicle secondary circuit. The higher temperature of the fluid is based at least partially on heat transfer in the secondary heat exchanger. The secondary heat exchanger can in this case form the abovementioned heat source. The passive ambient heat exchanger may be fluidically connected to the vehicle secondary circuit in parallel with the heating heat exchanger. In other words, the fluid flow coming from the secondary heat exchanger is split and flows in parallel partial flows through the heating heat exchanger and through the at least one passive ambient heat exchanger, respectively. The partial flows are combined again and flow together through the secondary heat exchanger again.

The heat transport system may have at least one sensor, wherein the de-icing criterion is based at least partially on measurement data from the at least one sensor. Each sensor can be connected in a signal-transmitting manner to the system control unit such that the system control unit can directly receive these measurement data from the sensor. In particular, the measurement data from the sensor can provide information about the need for de-icing. In other words, the system control unit can be designed in particular to identify the need for de-icing at least partially on the basis of the measurement data. Each sensor can be in the form, for example, of a temperature sensor. In this case, it is possible, for example, for a temperature of the ambient heat exchanger, of the fluid within the latter or a temperature of the surroundings to be detected. A further possibility would be an optical sensor or an ultrasonic sensor, by which a layer of ice can be identified. A further possibility would be to monitor by use of sensors an air flow that flows through the ambient heat exchanger. By use of pressure sensors, a pressure difference between opposite sides of the ambient heat exchanger could be determined. If this pressure difference increases, this may indicate that the flow resistance has increased on account of a layer of ice. It is also possible for the speed of the air flow to be monitored via flow sensors. If the speed drops in certain regions, this may also indicate an increased flow resistance on account of a layer of ice.

In one configuration, the system control unit is designed to determine, for at least one ambient heat exchanger, an icing index which may correspond to the difference between a fluid temperature associated with this ambient heat exchanger and an ambient temperature, and to identify the need for de-icing at least partially on the basis of the icing index. The icing index may, in particular, be a measure of the probability of icing up of the ambient heat exchanger or of the extent of such icing up. In this case, the icing index may, in particular, be associated with the type of the abovementioned sensors that are used. For example, the icing index could be a pressure difference between opposite sides of the ambient heat exchanger or be based on this pressure difference. Alternatively, the icing index could be based on a flow rate of the air flow. In particular, however, the icing index can be temperature-based. In this case, it can correspond to a fluid relative temperature that represents the difference between the abovementioned fluid temperature and the ambient temperature. The ambient temperature can correspond to an air temperature in the surroundings of the vehicle. The fluid temperature associated with the ambient heat exchanger may correspond in particular to a temperature of the fluid which has just flowed through the ambient heat exchanger. The fluid relative temperature may also be referred to as a fluid temperature difference. It corresponds to the difference between the fluid temperature and the ambient temperature. In the heating mode, for effective heat transfer to the fluid, the fluid temperature should be below the ambient temperature, i.e. the fluid temperature difference should be negative. However, if the fluid temperature is too far below the ambient temperature and if the fluid temperature difference thus lies too far in the negative range, this indicates impaired heat transfer and thus icing up. If the fluid temperature of the i-th ambient heat exchanger is denoted Tfi,_{Fi}, the ambient temperature is denoted T_{U}, the fluid temperature difference is denoted T_{FDi} and a comparative value is denoted T_{V}, the following inequality can serve as a criterion for icing up:

T_{Fi}−T_{U}=T_{FDi}<T_{V}

In other words, if this inequality is satisfied and thus the fluid temperature difference lies below the comparative value, this is evaluated as an indication of icing up. The comparative value could be specified constantly, but it can also be calculated depending on other parameters, in particular environmental parameters, or determined on the basis of a look-up table. Regardless of the type of icing index, the determined icing index can be compared with a comparative value and the need for de-icing can be identified depending on the comparison. This includes the possibility of identifying the need for de-icing on the basis of further factors in addition to the comparison.

In one embodiment, the system control unit is designed to select the at least one passive ambient heat exchanger at least partially on the basis of a comparison of icing indices of a plurality of ambient heat exchangers. In this case, provision can be made, in particular, for that ambient heat exchanger or those ambient heat exchangers to be selected that has/have an icing index that indicates the greatest icing up and/or possibility of icing up. Thus, in the de-icing mode, first of all that ambient heat exchanger is de-iced or those ambient heat exchangers are de-iced in which there is presumably the greatest icing up and thus the greatest impairment of functionality. Alternatively, however, it would also be conceivable for specifically an ambient heat exchanger with little icing up to be selected, since in that case the icing can be removed particularly quickly. Even if one or more ambient heat exchangers are selected to be passive on account of their icing index, while other, possibly likewise iced-up ambient heat exchangers continue to be operated actively, it goes without saying that the latter can likewise be de-iced subsequently by being transferred to a different de-icing mode.

In one embodiment, the system control unit is designed to select the at least one passive ambient heat exchanger at least partially on the basis of a defined prioritization of the ambient heat exchangers. The prioritization defines an order or priority of the ambient heat exchangers. In this case, the prioritization is predefined and does not depend on the current state (i.e., for example, on the icing index) of the ambient heat exchangers. Selecting on the basis of a prioritization can, in particular, take place as an alternative to selecting on the basis of an icing index. However, mixed forms, for example, are also conceivable, wherein the prioritization and the icing index could be weighted. Thus, for example, a particularly significantly iced-up ambient heat exchanger with low priority could be selected as a passive ambient heat exchanger, while a less significantly iced-up ambient heat exchanger with a higher priority could be disregarded. Potentially, the prioritization may also mean that the need for de-icing of at least one ambient heat exchanger with a lower priority is not checked if the need for de-icing of at least one ambient heat exchanger with a higher priority has already been established.

According to one configuration, the system control unit is designed to transfer the heat transport system into a de-icing mode depending on whether a need for de-icing is identified in a plurality of ambient heat exchangers that corresponds at least to a defined minimum number. In other words, even if a need for de-icing has been identified in a single ambient heat exchanger, a de-icing mode is still not initiated. This occurs only when a minimum number of ambient heat exchangers exhibit a need for de-icing, for example, at least two, three, or more. Approach may be advantageous in particular when there is a relatively large number of ambient heat exchangers, since the heat transport system is only changed over when a particular number of ambient heat exchangers is iced up, while possible icing up of a single ambient heat exchanger impairs overall operation only little and is thus acceptable. As soon as the minimum number has been reached, the de-icing can potentially be carried out more efficiently.

Advantageously, the system control unit is designed, in the de-icing mode, to check the need for de-icing of a passive ambient heat exchanger and to operate the latter as an active ambient heat exchanger if there is no longer a need for de-icing. The need for de-icing can be checked on the basis of the abovementioned icing index. A check can be carried out, for example, repeatedly, wherein there may be a predefined time interval between the individual checks. If a need for de-icing is no longer identified, it would be inefficient to continue to operate the ambient heat exchanger passively. Therefore, in this embodiment, the system control unit initiates a changeover from passive to active. This may correspond to the entire heat transport system being transferred into the heating mode or into another de-icing mode, in which the de-icing of at least one other heat exchanger is continued or started. In the latter case, first of all one ambient heat exchanger is de-iced and then another.

The heat transport system may have an adjustable blocking unit, which is actuable or actuated by the system control unit such that, in the de-icing mode, compared with the heating mode, it reduces a first partial air flow that flows into at least one passive ambient heat exchanger in relation to a second partial air flow that flows into at least one active ambient heat exchanger. The blocking unit serves to influence the air flow and can block the latter at least partially and/or locally. The blocking unit may be adjustable by a motor. Parts or subregions of the blocking unit can be assigned to individual ambient heat exchangers. For example, a first part can be arranged upstream of a first ambient heat exchanger in the direction of air flow, while a second part is arranged upstream of a second ambient heat exchanger in the direction of air flow, etc. The blocking unit may have a plurality of blocking elements, which can be connected, for example, movably to a frame of the air passage arrangement. In particular, each blocking element may be pivotable. It may, for example, be in the form of a flap or slat. As a result of the blocking unit being adjusted, a first partial air flow that flows into the passive ambient heat exchanger in the heating mode can be reduced in the de-icing mode. This relates not only to an absolute reduction, but also, in particular, to a reduction in relation to a second partial air flow that flows into the active ambient heat exchanger. In other words, in particular at low ambient temperatures, heat transfer from the passive ambient heat exchanger to the ambient air is minimized. In particular, the first partial air flow can be reduced to zero in the de-icing mode and be completely blocked. The blocking unit is actuable by the system control unit and may be connected to the system control unit in a signal-transmitting manner at least on one side, either by wire or wirelessly. The system control unit actuates the blocking unit such that the latter is set in accordance with the heating mode or in accordance with the de-icing mode.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A heat transport system for a vehicle, the heat transport system comprising:
a plurality of ambient heat exchangers, each designed for heat exchange with an air flow and, in a heating mode of the heat transport system, fluidically connected via an ambient circuit to a primary heat exchanger such that heat is supplied at least indirectly to a vehicle zone; and
a control unit designed to apply a defined de-icing criterion in order to establish a need for de-icing in at least one of the plurality of ambient heat exchangers, to select the at least one of the plurality of ambient heat exchangers as a passive ambient heat exchanger and to transfer the heat transport system into a de-icing mode in which at least one active ambient heat exchanger is fluidically connected to the primary heat exchanger, while fluid exchange between the passive ambient heat exchanger and the primary heat exchanger is restricted compared with the heating mode.

2. The heat transport system according to claim 1, wherein the primary heat exchanger is fluidically connected to a secondary heat exchanger by a primary circuit, wherein the primary circuit is configured as a heat pump circuit and has a compressor and an expansion valve, and wherein, in the heating mode, heat is transferable from the primary heat exchanger to the vehicle zone via the secondary heat exchanger, and wherein the ambient circuit forms an ambient secondary circuit.

3. The heat transport system according to claim 1, wherein the secondary heat exchanger is fluidically connected via a vehicle secondary circuit to a heating heat exchanger which is assigned to the vehicle zone, wherein, in the de-icing mode, the at least one passive ambient heat exchanger is fluidically connected to the vehicle secondary circuit via a connecting arrangement in parallel with the heating heat exchanger.

4. The heat transport system according to claim 1, further comprising a sensor, wherein the de-icing criterion is based at least partially on measurement data from the at least one sensor.

5. The heat transport system according to claim 1, wherein the system control unit is designed to determine, for at least one ambient heat exchanger, an icing index which corresponds to a difference between a fluid temperature associated with the at least one ambient heat exchanger and an ambient temperature, and to identify a need for de-icing at least partially based on the icing index.

6. The heat transport system according to claim 1, wherein the system control unit is designed to select the at least one passive ambient heat exchanger at least partially based on a comparison of icing indices of a plurality of ambient heat exchangers.

7. The heat transport system according to claim 1, wherein the system control unit is designed to select the at least one passive ambient heat exchanger at least partially based on a defined prioritization of the ambient heat exchangers.

8. The heat transport system according to claim 1, wherein the system control unit is designed to transfer the heat transport system into a de-icing mode depending on whether a need for de-icing is identified in a plurality of ambient heat exchangers that corresponds at least to a defined minimum number.

9. The heat transport system according to claim 1, wherein the system control unit is designed, in the de-icing mode, to check a need for de-icing of a passive ambient heat exchanger and to operate the latter as an active ambient heat exchanger if there is no longer a need for de-icing.

10. The heat transport system according to claim 1, further comprising an adjustable blocking unit, which is actuable by the system control unit such that, in the de-icing mode, compared with the heating mode, the adjustable blocking unit reduces a first partial air flow that flows into at least one passive ambient heat exchanger in relation to a second partial air flow that flows into at least one active ambient heat exchanger.

11. A heat transport system for a vehicle, the heat transport system comprising:
a plurality of ambient heat exchangers, which is designed for heat exchange with an air flow and, in a heating mode of the heat transport system, fluidically connected via an ambient circuit to a primary heat exchanger such that heat is supplied at least indirectly to a vehicle zone, wherein the primary heat exchanger is fluidically connected to a secondary heat exchanger by a primary circuit, wherein the primary circuit is configured as a heat pump circuit and has a compressor and an expansion valve, and wherein, in the heating mode, heat is transferable from the primary heat exchanger to the vehicle zone via the secondary heat exchanger, wherein the ambient circuit forms an ambient secondary circuit, and wherein the secondary heat exchanger is fluidically connected via a vehicle secondary circuit to a heating heat exchanger which is assigned to the vehicle zone, wherein, in a de-icing mode, the at least one passive ambient heat exchanger is fluidically connected to the vehicle secondary circuit via a connecting arrangement in parallel with the heating heat exchanger;
a control unit designed to apply a defined de-icing criterion in order to establish a need for de-icing in at least one of the plurality of ambient heat exchangers, to select the at least one of the plurality of ambient heat exchangers as a passive ambient heat exchanger and to transfer the heat transport system into the de-icing mode in which at least one active ambient heat exchanger is fluidically connected to the primary heat exchanger, while fluid exchange between the passive ambient heat exchanger and the primary heat exchanger is restricted compared with the heating mode; and
a sensor, wherein the de-icing criterion is based at least partially on measurement data from the at least one sensor.

12. The heat transport system according to claim 11, wherein the control unit is designed to determine, for at least one ambient heat exchanger, an icing index which corresponds to a difference between a fluid temperature associated with the at least one ambient heat exchanger and an ambient temperature, and to identify a need for de-icing at least partially based on the icing index.

13. The heat transport system according to claim 11, wherein the control unit is designed to select the at least one passive ambient heat exchanger at least partially based on a comparison of icing indices of a plurality of ambient heat exchangers.

14. The heat transport system according to claim 11, wherein the control unit is designed to select the at least one passive ambient heat exchanger at least partially based on a defined prioritization of the ambient heat exchangers.

15. The heat transport system according to claim 11, wherein the control unit is designed to transfer the heat transport system into a de-icing mode depending on whether a need for de-icing is identified in a plurality of ambient heat exchangers that corresponds at least to a defined minimum number.

16. The heat transport system according to claim 11, wherein the control unit is designed, in the de-icing mode, to check a need for de-icing of a passive ambient heat exchanger and to operate the latter as an active ambient heat exchanger if there is no longer a need for de-icing.

17. The heat transport system according to claim 11, further comprising an adjustable blocking unit, which is actuable by the control unit such that, in the de-icing mode, compared with the heating mode, the adjustable blocking unit reduces a first partial air flow that flows into at least one passive ambient heat exchanger in relation to a second partial air flow that flows into at least one active ambient heat exchanger.
